(19) United States
(12) Patent Application Publication
(10) Pub. No.: US 2026/0127706 A1
(43) Pub. Date: May 7, 2026

(54) METHOD AND SYSTEM FOR GRADIENT-BASED PIXEL INTERPOLATION IN A RANGE IMAGE

(71) Applicant: TELEFONAKTIEBOLAGET LM ERICSSON (PUBL), STOCKHOLM (SE)

(72) Inventor: Jin Heo, Atlanta, GA (US)

(21) Appl. No.: 19/117,359

(22) PCT Filed: Sep. 29, 2023
(86) PCT No.: PCT/US2023/034178

§ 371 Date: Mar. 31, 2025

Related U.S. Application Data
(60) Provisional application No. 63/411,229, filed on Sep. 29, 2022.

(51) Int. Cl. G06T 3/4007; G06T 3/4023; G06T 7/10

(52) U.S. Cl. CPC G06T 3/4007; G06T 3/4023; G06T 7/10; G06T 2207/20021

(57) ABSTRACT

Embodiments perform gradient-based interpolating pixels. In one embodiment, a method comprises: converting point cloud data into one or more range images, wherein each pixel in a range image within the one or more range images is to map to a point represented by a set of cartesian coordinates in the point cloud; dividing a range image within the one or more range images into a plurality of windows, each window including a set of pixels in the range image; adding one or more pixels to at least one window through interpolation of pixels within the window, wherein one or both gradients between a first pixel and the first pixel's two immediately adjacent pixels in the window are used to determine a first interpolated pixel to be added; and converting pixels within the plurality of windows with one or more interpolated pixels into updated point cloud data of the point cloud.

### TECHNICAL FIELD

Embodiments of the invention relate to the field of computing; and more specifically, to performing gradient-based interpolating pixels in a range image.

### BACKGROUND

Using data collected based on one or more sensors, localization and mapping (often referred to as simultaneous localization and mapping (SLAM)) algorithms/techniques may construct or update a map of an environment while keeping track of the sensors' location within it. Such localization and mapping algorithms/techniques are used in applications such as extended reality (XR) and autonomous driving/robotics. Localization may acquire a sensor's pose (position and rotation) in a three-dimensional (3D) space, while mapping may acquire and store information about a scene to support future localization. A sensor may send sensor signals (e.g., a laser or a radio wave), which reach an object and reflect back. The intensity of waves returning to the sensor after reflection is referred to as reflectance intensity. The reflectance intensity of an object may be measured as the ratio between the emitted radiant energy to an object and the radiant energy reflected from the object as measured by a sensor; and the reflectance intensity, the sensor's pose, and other measurements are data to be collected for performing the localization and mapping.

The collected data may be used to construct a three-dimensional (3D) point cloud. A 3D point cloud (also referred to as point cloud, point cloud map, or simply map) is a set of data points representing a physical region (also referred to as space). The points of a point cloud may represent a 3D object in the physical region. Each point position may be represented by a set of Cartesian coordinates (x, y, z) and optionally other attributes such as the corresponding reflectance intensity. These points may be converted to a number of structured representations in various use cases. The range image (RI) is one of the representations, and it is generated by mapping the 3D points of a point cloud into a number of range images.

The conversion from the 3D points to range images can be lossy to achieve processing efficiency. It is challenging to enhance the resolution of the range images after the lossy conversion.

### SUMMARY

Embodiments include methods, electronic devices, machine-readable storage media, and programs to perform gradient-based interpolating pixels in a range image. In one embodiment, a method to be implemented in an electronic device to interpolate pixels comprises: converting point cloud data of a point cloud into one or more range images, wherein each pixel in a range image within the one or more range images is to map to a point represented by a set of cartesian coordinates in the point cloud and is represented by a depth value, a polar angle, and an azimuthal angle; dividing a range image within the one or more range images into a plurality of windows, each window including a set of pixels in the range image; adding one or more pixels to at least one window through interpolation of pixels within the window, wherein one or both gradients between a first pixel and the first pixel's two immediately adjacent pixels in the window are used to determine a first interpolated pixel to be added; and converting pixels within the plurality of windows with one or more interpolated pixels into updated point cloud data of the point cloud.

Embodiments include electronic devices to perform gradient-based interpolating pixels in a range image. In one embodiment, an electronic device comprises a processor and machine-readable storage medium that provides instructions that, when executed by the processor, are capable of causing the electronic device to perform: converting point cloud data of a point cloud into one or more range images, wherein each pixel in a range image within the one or more range images is to map to a point represented by a set of cartesian coordinates in the point cloud and is represented by a depth value, a polar angle, and an azimuthal angle; dividing a range image within the one or more range images into a plurality of windows, each window including a set of pixels in the range image; adding one or more pixels to at least one window through interpolation of pixels within the window, wherein one or both gradients between a first pixel and the first pixel's two immediately adjacent pixels in the window are used to determine a first interpolated pixel to be added; and converting pixels within the plurality of windows with one or more interpolated pixels into updated point cloud data of the point cloud.

Embodiments include machine-readable storage media to perform gradient-based interpolating pixels in a range image. In one embodiment, a machine-readable storage medium stores instructions which, when executed, are capable of causing an electronic device to perform operations, comprising: converting point cloud data of a point cloud into one or more range images, wherein each pixel in a range image within the one or more range images is to map to a point represented by a set of cartesian coordinates in the point cloud and is represented by a depth value, a polar angle, and an azimuthal angle; dividing a range image within the one or more range images into a plurality of windows, each window including a set of pixels in the range image; adding one or more pixels to at least one window through interpolation of pixels within the window, wherein one or both gradients between a first pixel and the first pixel's two immediately adjacent pixels in the window are used to determine a first interpolated pixel to be added; and converting pixels within the plurality of windows with one or more interpolated pixels into updated point cloud data of the point cloud.

By implementing embodiments as described, interpolation in a range image considers existence of points in the three-dimensional space and validity of continuity of an interpolating pixel within the range image, and such interpolation enhance the quality of the range image so it may be used to build a more accurate point cloud reflecting the three-dimensional space from which the range image was constructed. The more accurate point cloud leads to better localization in applications such as extended reality (XR) and autonomous driving/robotics.

### BRIEF DESCRIPTION OF THE DRAWINGS

The invention may best be understood by referring to the following description and accompanying drawings that are used to illustrate embodiments of the invention. In the drawings:

FIG. 1 shows point cloud construction with range image interpolation according to some aspects of the present disclosure.

FIG. 2 is a flow diagram illustrating an overall flow of range image interpolation according to some aspects of the present disclosure.

FIG. 3 is a flow diagram illustrating range image interpolation in a window within a range image according to some aspects of the present disclosure.

FIG. 4 is a flow diagram illustrating the gradient determination for a pixel in a window within a range image according to some aspects of the present disclosure.

FIG. 5 is a flow diagram illustrating adding a pixel through interpolation based on gradients for a pixel in a window within a range image according to some aspects of the present disclosure.

FIG. 6 is a flow diagram illustrating operations to perform range image interpolation based on gradients according to some aspects of the present disclosure.

FIG. 7 is an electronic device that supports prediction of reflectance intensity using heterogenous sensors according to some aspects of the present disclosure.

FIG. 8 illustrates an example of a communication system according to some aspects of the present disclosure.

FIG. 9 illustrates a user equipment (UE) according to some aspects of the present disclosure.

The figures will be best understood by reference to the following Detailed description.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

Point Cloud Construction with Range Image Interpolation

Embodiments of the invention aim at interpolating range images to enhance range images to represent the environment based on which the range images are constructed. The better range images may be used in applications such as extended reality (XR) and autonomous driving/robotics.

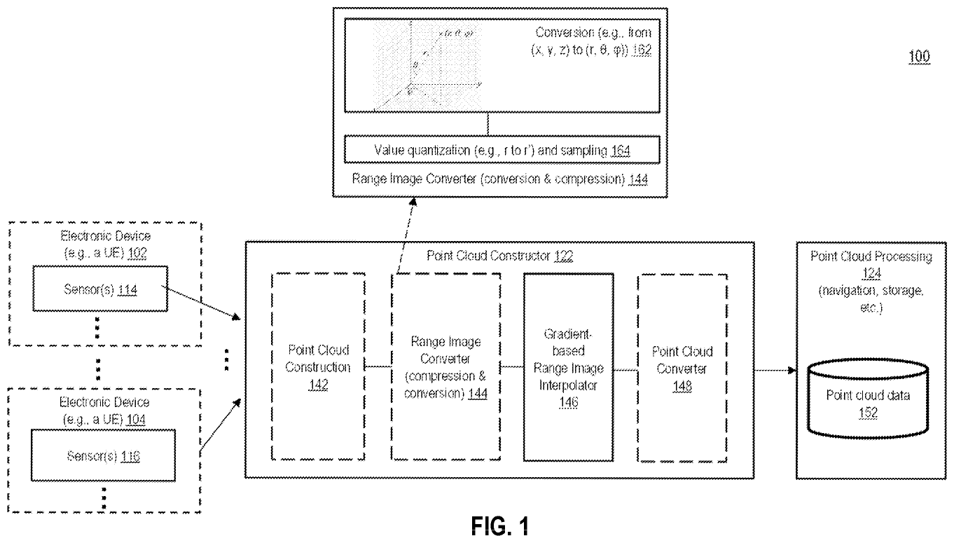

FIG. 1 shows point cloud construction with range image interpolation according to some aspects of the present disclosure. A system 100 includes electronic devices 102 to 104 to collect data from an environment (e.g., a physical environment such as open/urban roads or office buildings, and/or a virtual/augmented environment including computer graphics objects). The electronic devices 102 to 104 may be a smartphone, a head-mounted display unit, a surveying unit, a robot, a vehicle system or subsystem.

The system 100 further includes a point cloud constructor 122 to build and enhance one or more point clouds to represent the physical environment, and a point cloud processing module 124 to apply the one or more point clouds to applications such as navigation (including object detection and recognition) and/or to store the point cloud data 152 in a database for further processing. Note while these entities are shown separated in the figure, two or more of these entities may be integrated into single hardware circuitry and/or system-on-chip (Soc), and common functional blocks such as processors and memory are ignored to focus on inventive aspects of the system.

The data collection electronic devices 102 to 104 includes sensors, such as sensors 114 and 116, respectively. These sensors may include a variety of types that operate at different wavelengths, such as red, green, and blue (RGB) camera sensors, light detection and ranging (LiDAR) sensors, and motion sensors. These sensors allow an electronic device to capture data such as the reflectance intensity of an object at several wavelengths or wavelength ranges, and multiple electronic devices including these sensors with different poses may capture the data at different positions/locations so that the integration of the collected data may be used to accurately capture the environment in which these electronic devices operate. A data collection electronic device may be a mobile device (e.g., a user equipment (UE) or another wireless device) or another end-user device in some embodiments.

The data collected from electronic devices 102 to 104 (and/or other electronic devices) may be collected by a point cloud construction module 142 to build one or more point clouds to represent the environment. The point cloud construction module 142 may constructs a single 3D point cloud based on reflectance intensity data collected from multiple sensors in different electronic devices (e.g., from local point clouds, each built from one sensor, to aggregate to form a single global point cloud that incorporates and aligns multiple local point clouds using data from the multiple sensors). Each point in a point cloud may be represented by a set of Cartesian coordinates (x, y, z) and optionally other attributes such as the corresponding reflectance intensity at the point.

The figure shows that, in some embodiments, the point cloud construction module 142 is optionally implemented in a point cloud constructor 122 (implemented in an electronic device) that also include an optional range image converter 144, a gradient-based range image interpolator 146, and an optional point cloud converter 148. In other embodiments, the point cloud construction module 142 is integrated into a data collection electronic device (e.g., within electronic device 102 or 104). Alternatively, the point cloud construction module 142 is implemented in another (mobile) electronic device, apart from the gradient-based range image interpolator 146. Similarly, the range image converter 144 and the point cloud converter 148 may be implemented in one or more other (mobile) electronic devices apart from the gradient-based range image interpolator 146 as well.

A point cloud includes a sequence of 3D point values, which may be converted into a structured representation in various use cases. The range image (RI) is one of the representations, and it is generated by mapping the 3D points of a point cloud into a set of range images. A range image converter 144 may perform the conversion of the 3D points.

The conversion, from a set of Cartesian coordinate values of a point in a point cloud to a set of spherical coordinate values of a pixel in a range image, may use the following equations:

$$\begin{matrix}r = \sqrt{{x}^{2} + {y}^{2} + {z}^{2}} & θ = arccos ( \frac{z}{r} ) & ϕ = arctan ( \frac{y}{x} )\end{matrix} \qquad ( 1 )$$

The value r represents the radial distance of that point from a fixed origin and is referred to as the depth value; θ is the polar angle measured from a fixed zenith direction, and φ is the azimuthal angle of its orthogonal projection on a reference plane that passes through the origin and is orthogonal to the zenith, measured from a fixed reference direction on that plane. Each pixel in a range image has the depth value (r) (e.g., the distance between a sensor and an object from which the sensor signal is reflected), and the mapping location in a 2D frame is determined by normalizing the converted polar and azimuthal angles (θ, φ) to the sensor's field of view.

The conversion module 162 within the range image converter 144 performs the coordinate conversion. Through the range image conversion, the original point cloud is naturally compressed, because three coordinate values of each point (x, y, z) can be encoded with just a range value r of the corresponding pixel in the range image; θ and φ are the pixel's coordinates and do not have to be explicitly encoded. If θᵣ and φᵣ are having the same as the resolutions of the sensor (e.g., a LiDAR), a range image is a lossless compression of the corresponding point cloud. Mathematically, however, θᵣ and φᵣ could be any arbitrary positive values; larger θᵣ and φᵣ would lead to a lower range image resolution, providing a lossy compression of the original point cloud in the conversion to the range images.

Additionally, the range image converter 144 includes a value quantization and sampling module 164 that may quantize the resulting pixels (r, θ, φ). The values r, θ, φ are typically floating-point values, and each may be represented by a number of bits in processing. The number of bits may be from 8-bit and 16-bit to 128-bit, 256-bit and even more. The more bits a value takes, the more storage, computing, and/or bandwidth resources the value will take for processing. Quantization is a process to use smaller number of bits to represent the values r, θ, φ as the number of bits would take to represent them as the values being produced by Formula (1). Quantization is a lossy compression process, and it may be applied to each coordinate of the sets of set of spherical coordinate values (r, θ, φ). Such quantization further reduces the computation complexity in processing data in the range images.

The value quantization and sampling module 164 may also sample points from the point clouds to convert to range images. That is, the value quantization and sampling module 164 may select only a subset of the point cloud data of the point cloud to convert to range images. The sampling may be prioritized based on application type for which the point cloud is to be used and the area of a point cloud that is of interest. For example, the sampling may select more points within a region of interest (e.g., where an XR user's eyes is currently viewing) of a point cloud than outside of the region. Also, the sampling may be more extensive for points closer to the sensor that the ones further away (e.g., in autonomous driving, detecting the closer objects are more important). In other embodiments, the sampling may be more evenly distributed (e.g., selecting one point in every n points in the point cloud). Embodiments of the inventions support interpolating range images generated through any quantization and/or sampling approaches.

Through value quantization and/or sampling at the value quantization and sampling module 164, a resulting range image is a lossy representation of the corresponding point cloud from which the pixels in the range image are converted. Such range image may provide advantages over the corresponding point cloud in several aspects. For example, operating on a range image can be computationally more efficient than directly accessing the point cloud, which requires tree traversals that lead to high cache misses and branch mis-predictions in execution by a computer processor. Additionally, adjacent pixels in the range map are likely to lie on the same plane, because they correspond to consecutive scans from a sensor (e.g., a LiDAR sensor). That characteristic allows encoding a range image to be more efficiently than encoding a corresponding point cloud.

Furthermore, the lossy conversion results in less data to process; and processing the less data in the range image thus is more efficient than processing data in the corresponding point cloud data as the former takes less storage, computing, and/or bandwidth resources. The efficiency can be important in many localization and mapping applications that are mobile—e.g., XR typically requiring small form factor electronic device that has very limited storage, computing, and/or bandwidth resources.

For these reasons, implementing lossy conversion to convert point cloud data to range images is preferrable to processing the point cloud data directly. Yet a range image resulting from the lossy conversion represent less data and/or less data precision for the remaining data. Such data degradation may result in performance degradation in the localization and mapping applications. For example, with less data and/or less data precision, an object may not be accurately detected than otherwise.

To offset the lossy conversion, interpolation may be implemented to add pixels to a range image. With additional pixels, the range image may approximate, with less data and/or less data precision, the corresponding point cloud from which the range image is converted.

Existing image interpolation techniques blindly use the near pixel information to interpolate a new pixel, and such interpolation does little to enhance the quality of a range image. For example, the averaging the values of two nearest pixels generates an interpolated pixel in the middle (two points with depth values [a, b] may produce three points with depth values [a, (a+b)/2, b] with the interpolated depth value of (a+b)/2. Yet such averaging does little to offset the lossy conversion. Experiments show that other interpolation methods to leverage the near-pixel information of a pixel fail to enhance the quality either, including bilinear, bicubic, and Lanczos interpolations. One reason is that neighboring pixels may come from empty space (depth value being zero) or be placed far away in the point cloud (e.g., near an edge in the space), and solely relying on pixels being close fails to consider the reality of the physical space, which the range image represents.

In contrast, embodiments of the invention use gradient-based range image interpolation to enhance the quality of range images. The enhancement is achieved through considering the validity of the continuity of an interpolating pixel by the gradients and/or the existence of points in the corresponding 3D space. By using the gradient magnitude of 2D pixels in a range image, embodiments of the invention leverage the continuity of 3D object shapes in the 3D space, as discussed in further details in the following sections.

After the interpolation, the updated range images may then be converted back to a point cloud through the point cloud converter 148. The conversion may be performed through the following equations:

$$x = r sin φcosθ \qquad ( 2 )$$

$$y = r sin φsinθ$$

$$z = r cos φ$$

The new point cloud as constructed has taken advantages of the range image processing and can then be used for further point cloud processing at reference 124.

Through the gradient-based range image interpolation, embodiments of the invention may execute more computationally efficient perception tasks (such as object detection and recognition) and more efficient image-based learning processes, and additionally provide greater efficiencies downstream with respect to energy consumption and resource usage at the device and/or cloud level.

### Gradient-Based Range Image Interpolation

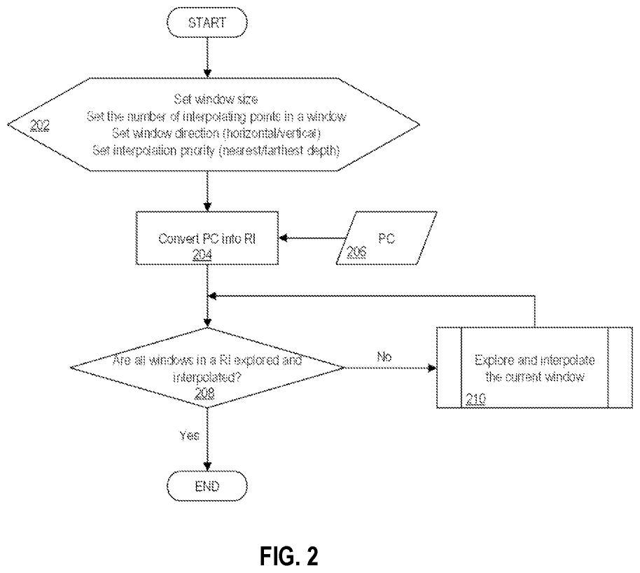

FIG. 2 is a flow diagram illustrating an overall flow of range image interpolation according to some aspects of the present disclosure. The operations may be performed by the gradient-based range image interpolator 146. The gradient is computed between two pixels based on the depth values of the two pixels in some embodiments.

At reference 202, the parameters of interpolating a range image are set. The parameters include one or more of (1) a window size, (2) a number of interpolating points in the window, (3) the direction of the window, and (4) the interpolation priority in some embodiments.
(1) Window size: The number of pixels in a range image to be included in an interpolation operation. The window may be one dimensional or two dimensional. When the window is two dimensional, it may also be referred to as a tile/block. These pixels are the base pixels from which the additional pixels are interpolated.
(2) Number of interpolating points in the window: The number of pixels to be added in a window through interpolation.
(3) The direction of the window: The direction may be set to be horizontal or vertical. Since a gradient is between two pixels, the two pixels may be immediately adjacent horizontally or vertically in a range image. When the window is two dimensional, the window direction may be set horizontally, and the interpolation is performed one row after another; or it may be set vertically, and the interpolation is performed one column after another.
(4) The interpolation priority: The interpolation may be performed with the nearest pixel (the one with lowest depth value) first or furthest pixel (the one with the highest depth value), and after the interpolation of that pixel, select the next pixel in the window based on the priority. Alternatively, the priority may be given to the pixels that map to the region of interest in the environment captured by the corresponding point cloud so a higher resolution is provided through interpolation to enhance the vision quality of the region of interest. Embodiments of the invention is not limited to a particular way that the interpolation priority is set.

The interpolation priority may be based on application type for which the point cloud is to be used and/or the value quantization and/or sampling performed when the conversion to the range images is done. For example, the nearest pixels may be interpolated first because the application emphasize image quality near the observation point (e.g., in autonomous driving, detecting the closer objects are more important). Yet when the value quantization and/or sampling have produced too few pixels in the range images, the furthest pixel may be interpolated first to offset the impact of the quantization and/or sampling.

The setting of these parameters may be predetermined and/or learned through performing interpolation and getting the feedback of how the settings work. For example, the values of these parameters may be determined through machine learning, starting with default values. The machine learning models may use supervised learning, unsupervised learning, semi-supervised learning, or other types of learning. It can use artificial neural networks, decision trees, support-vector machines, regression analysis, Bayesian networks, genetic algorithms, or any other framework. The machine learning models may be trained with the one or more goals of the resulting in better point cloud for point cloud processing 124.

At reference 204, a point cloud (at reference 206) is converted into one or more range images. The conversion may be performed at the range image converter 144 discussed herein above. A range image is then divided into multiple windows based on the settings of the parameters of interpolating determined at reference 202.

Then at reference 208, it is determined whether all the windows of a range image are explored and interpolated. If not, the flow goes to reference 210, and a current remaining window is explored and interpolated. Once that's done, the flow goes back to reference 208 to determine whether all the windows of the range image are processed. After iterating through all windows, the process is complete, and all the interpolated pixels have been added to the targeted range image.

The process may be repeated for all the range images resulting from a point cloud when more than one range image is generated from the point cloud. The enhanced range image(s) may then be converted to a point cloud at the point cloud converter and perform further point cloud processing at reference 124 as discussed herein above. Note that a subset or all of the windows of a range image may be interpolated concurrently in some embodiments. The concurrent interpolation of the windows takes advantage of single instruction multiple data (SIMD) and/or single instruction multiple threads (SIMT) computing architecture to make the range image interpolation more efficient.

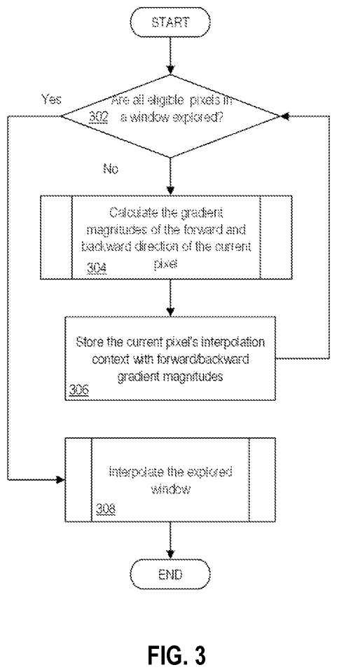

FIG. 3 is a flow diagram illustrating range image interpolation in a window within a range image according to some aspects of the present disclosure. The operations may be performed by the gradient-based range image interpolator 146.

At reference 302, it is determined whether all eligible pixels in a window are explored. The pixels in a window are ordered for interpolation based on priority in some embodiments (see reference 202 for interpolation priority). The number of interpolating points in the window has been set, and if the already interpolated points in the window has reached the number, no more pixels in the window need to be explored, otherwise the process continue to reference 304.

At reference 304, the gradient magnitudes of the forward and backward direction of a current pixel (also referred to as the base pixel and the two terms are used interchangeably) are calculated. The gradient magnitude of the forward direction is the absolute difference between the current pixel and the next pixel in the range image. The next pixel is the immediately next pixel in the window. The gradient magnitude of the backward direction is the absolute different between the current pixel and the immediately previous pixel in the window in some embodiments.

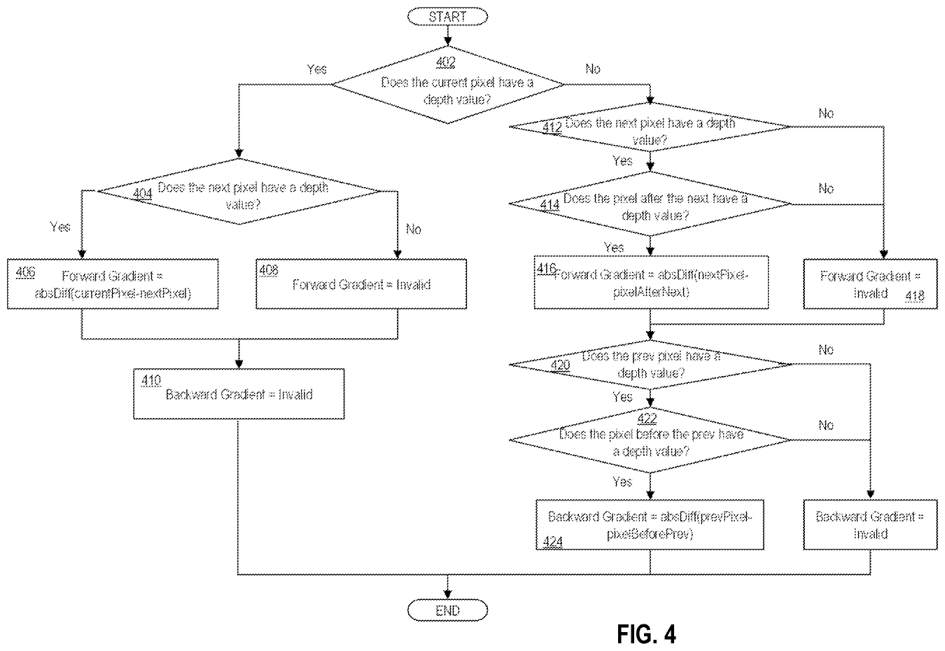

Mathematically a gradient value can be either positive or negative, the absolute slope of change is of interest for interpolation, so the absolute difference is calculated, and the corresponding gradient magnitude, a non-negative value, is used for interpolation. Unless noted otherwise, the gradient or gradient value herein refers to the gradient magnitude. For example, a window of 5 pixels may have depth values of [2 6 14 12 8], where the pixel with depth value of 14 is the current pixel (underlined). The forward gradient magnitude is 2 (|base depth value (14)−next depth value (12)|=2) and backward gradient magnitude is 8 ((|base depth value (14)−previous depth value (6)|=8. Note that the forward/backward gradient may be set to be other than the absolute difference, as shown in FIG. 4 herein below.

At reference 306, the current pixel's interpolation context is stored with the computed forward and/or backward gradient magnitudes. The interpolation context includes the gradient and base depth value of the current pixel. The stored interpolation context and the forward and/or backward gradient magnitudes are used to determine the depth value of the interpolated pixel for the current pixel, as discussed in further details herein.

When more eligible pixels are left in the window to explore, the flow returns to reference 302, and the process continue until it determines that all eligible pixels in the window are explored, and the flow goes to reference 308 and the interpolated pixels are included in the window.

FIG. 4 is a flow diagram illustrating the gradient determination for a pixel in a window within a range image according to some aspects of the present disclosure. The operations may be performed by the gradient-based range image interpolator 146. The pixel is the current pixel discussed in FIG. 3.

At reference 402, it's determined whether the current pixel has a depth value. If so, the flow goes to reference 404 to determine whether the next pixel has a depth value. If so, the forward gradient value is set to be absDiff(currentPixel−nextPixel), which is the gradient magnitude between the depth values of current and next pixels in the window (the absolute difference of the depth values). If not, the forward gradient value is set to be invalid. The two branches convert at reference 410. The backward gradient is set to be invalid to prevent the redundant interpolations of a sequence of pixels having depth values. The forward and backward gradients are stored for the current pixel.

Back to reference 404, when the current pixel does not have a depth value, the flow goes to reference 412 to determine whether the next pixel have a depth value. If so, the flow goes to reference 414 to determine whether the pixel after the next pixel have a depth value. If so, the forward gradient value is set to be absDiff(nextPixel−pixelAfterNext), which is the gradient magnitude between the depth values of the next pixel and the pixel after the next pixel in the window. If either determination at references 412 and 412 is negative, the flow goes to reference 418, and the forward gradient is set to invalid.

For example, a window of 5 pixels may have depth values of [2 6 0 14 16], where the current pixel has depth value of 0, which means that it does not have a mapped 3D point in the point cloud (no object in the 3D environment at the point). The forward gradient will be 2, since the next pixel and the pixel after the next pixel have depth values of 14 and 16, respectively.

At reference 420, it's determined whether the previous pixel have a depth value. If so, the flow goes to reference 422 to determine whether the pixel before the previous pixel have a depth value. If so, the backward gradient value is set to be absDiff(prevPixel−pixelBeforePrev), which is the gradient magnitude between the depth values of the previous pixel and the pixel before the previous pixel in the window. If either determination at references 420 and 422 is negative, the flow goes to reference 426, and the back gradient is set to invalid.

For the same window of 5 pixels with depth values of [2 6 0 14 16], the backward gradient will be 4, since the previous pixel and the pixel before the next pixel have depth values of 6 and 2, respectively. Thus, the forward and backward gradients are set to be 2 and 4, respectively.

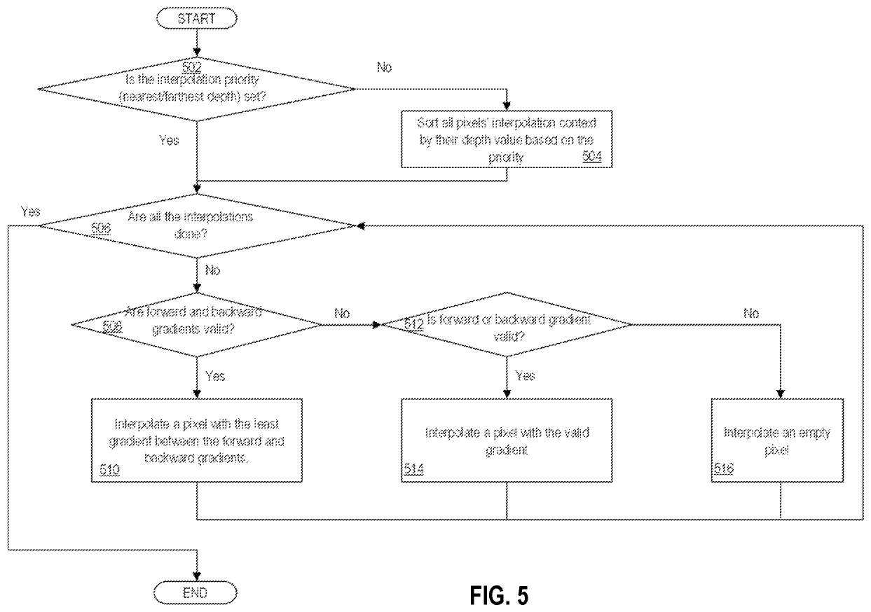

Through the operations in FIG. 4, the forward and backward gradients are set for a pixel in the window within the range image. When all the forward and backward gradients are determined, interpolation may be performed. FIG. 5 is a flow diagram illustrating adding a pixel through interpolation based on gradients for a pixel in a window within a range image according to some aspects of the present disclosure. The operations may be performed by the gradient-based range image interpolator 146.

At reference 502, it is determined whether the interpolation priority is set (e.g., the nearest or farthest depth first). If so, the flow goes to reference 506. If not, the flow goes to reference 504 to sort all the pixels' interpolation context by their depth value based on the set priority first and then goes to reference 506. The interpolation context of a pixel includes the gradient and base depth value of the pixel as discussed above.

At reference 506, it is determined whether all interpolations for the pixels are done. If not, the flow goes to reference 508 to determine whether both forward and backward gradients are valid for the current pixel. If so, a pixel is added with the least gradient between the forward and backward gradients at reference 510.

For example, the window of 5 pixels with depth values of [2 6 14 12 8], the forward gradient magnitude is 2 and backward gradient magnitude is 8, so an interpolated pixel is added with the least gradient of 2, and the depth value is half of the gradient magnitude plus the base value of 14: the interpolated depth value=base value (14)+½ of the least gradient (2)=13. Thus, the window after the interpolation has the depth values of [2 6 14 13 12 8], where the interpolated point having the depth value of 13 (shown with bold font).

For another example, the window of 5 pixels with depth values of [2 6 0 14 16], as discussed above, the current pixel with depth value of zero (no depth value as determined at reference 412) has the forward and backward gradients of 2 and 4, respectively. The forward gradient is selected, being the least gradient between 2 and 4. The added interpolated pixel will have the depth value of 12. That is, the interpolated depth value=base value (0)+the least gradient (2), not the half of the least gradient with the non-zero base value, so the window becomes [2 6 0 12 14 16]. That is, the gradient computation identifies an empty pixel, which has a zero depth value, and invalidates the gradient between a non-zero depth value pixel (representing an object in the environment captured by the point cloud) and the empty pixel. By considering the 3D environment in gradient computation, the interpolation enhances the quality of the range image.

Back to reference 508, if one of the forward or backward gradient is valid, the flow goes to reference 514, where a pixel is added with the valid gradient. For example, the interpolated depth value=base value+½ the valid gradient. On the other hand, if none of the forward or backward gradient is valid, the flow goes to reference 516, where a pixel is added with zero depth value and zero reflectance intensity (an empty pixel).

After adding the interpolated pixel is added for the current pixel, the flow returns to reference 506 to check if all interpolations are done. If not, the interpolation at references 510, 514, or 516 is done for the next pixel, until all interpolations are complete, and the process is finished for a window.

Once the depth value of the interpolated pixel is determined, the reflectance intensity value of the interpolated pixel may be set to the same as the current pixel in some embodiments. Because reflection value is one of the characteristics about the material of an object in the environment, it may be assumed that the interpolated pixel may be a part of the same object material. The additional attributes of the interpolated pixel may be taken from the current pixel as well.

Note that the examples given is about adding a single pixel for interpolation. In some embodiments, multiple interpolated pixels may be added. For example, two interpolation points may be added, with the first pixel with the depth value of base value+⅓ of the least gradient and the second pixel with the depth value of base value+⅔ of the least gradient.

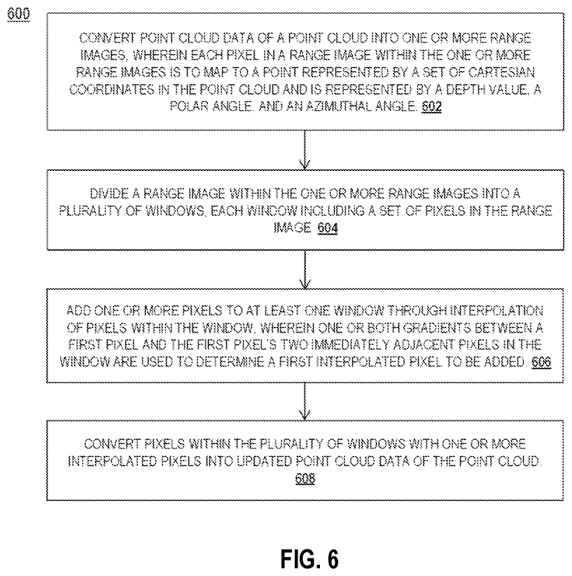

FIG. 6 is a flow diagram illustrating operations to perform range image interpolation based on gradients according to some aspects of the present disclosure. The operations of method 600 may be performed by an electronic device implementing the point cloud constructor 122 in some embodiments.

At reference 602, point cloud data of a point cloud is converted into one or more range images, where each pixel in a range image within the one or more range images is to map to a point represented by a set of cartesian coordinates in the point cloud and is represented by a depth value, a polar angle, and an azimuthal angle. The conversion may be performed through Formula (1) and the quantization/sampling of the value quantization and sampling module 164 discussed herein above.

At reference 604, a range image within the one or more range images is divided into a plurality of windows, each window including a set of pixels in the range image.

At reference 606, one or more pixels are added to at least one window through interpolation of pixels within the window, where one or both gradients between a first pixel and the first pixel's two immediately adjacent pixels in the window are used to determine a first interpolated pixel to be added. The interpolation of the 5-pixel window with depth values of [2 6 14 12 8] to [2 6 14 13 12 8] explained above shows an example of the interpolation of the first pixel. When only one gradient is valid, the interpolation uses the valid gradient only as discussed herein above.

At reference 608, pixels within the plurality of windows with one or more interpolated pixels into updated point cloud data of the point cloud. The conversion may be done through Formula (2) above.

In some embodiments, converting the point cloud data of the point cloud into the one or more range images comprises at least one of: selecting a subset of the point cloud data of the point cloud to map to the one or more range images, and quantizing the range image mapping.

In some embodiments, dividing the range image into a plurality of windows may be performed either vertically or horizontally.

In some embodiments, adding the one or more pixels to the at least one window may be prioritized based on depth values of the pixels within the window.

In some embodiments, the pixels with either lower depth values or higher depth values within the window are prioritized based on an application type to apply the point cloud data. Alternatively or additionally, the pixels with either lower depth values or higher depth values within the window are prioritized based on the impact of quantization and/or sampling so that the interpolation will offset the degradation due to quantization and/or sampling.

In some embodiments, adding pixels to the plurality of windows is performed in parallel. As discussed, such parallelism takes advantages of SIMD/SIMT computing architecture to make the range image interpolation more efficient.

In some embodiments, determining the first interpolated pixel comprises selecting a least gradient magnitude of the two gradients to determine the first interpolated pixel.

In some embodiments, a first interpolated depth of the first interpolated pixel is computed based on a first depth value of the first pixel and the least gradient magnitude.

In some embodiments, a second interpolated pixel is added when a second depth value of a second pixel is zero, and wherein the second interpolated pixel is added using two gradients, each for one immediately adjacent pixel of the second pixel and each gradient being a gradient on non-zero depth side of the one immediately adjacent pixel. For example, the window of 5 pixels with depth values of [2 6 0 14 16], as discussed above, has the current pixel (the second pixel) of depth value zero. To interpolate, it uses two gradients, one for each immediately adjacent pixel, left and right sides being 6 and 14, respectively. The gradient to use is the gradient of the left and right side pixels to the non-zero depth side, which is the gradient between [2 6] at the left and between [14 16] at the right. The gradients of 4 and 2 on the non-zero depth sides are used to identify the interpolated pixel, as discussed herein above.

In some embodiments, the first interpolated pixel is assigned a same reflectance intensity value of the first pixel.

Through gradient-based range image interpolation, the quality of range images is enhanced. The enhancement is achieved through considering the validity of the continuity of an interpolating pixel by the gradients and/or the existence of points in the corresponding point cloud. The gradients of a pixel to its immediately adjacent pixels are a good indication of the continuity of the points in the corresponding point cloud, and interpolation based on the gradients thus make the range image more accurate. When a point is not existence in the point cloud, the corresponding pixel in the range image has the zero depth value, and the gradients of its immediately adjacent pixels are used to approximate the continuity. By using the gradient magnitude of 2D pixels in a range image, embodiments of the invention leverage the continuity of 3D object shapes in the point cloud. The resulting updated point cloud converted from the range images with interpolated pixels is thus enhanced in many applications such as XR and autonomous driving/robotics.

### Devices Implementing Embodiments of the Invention

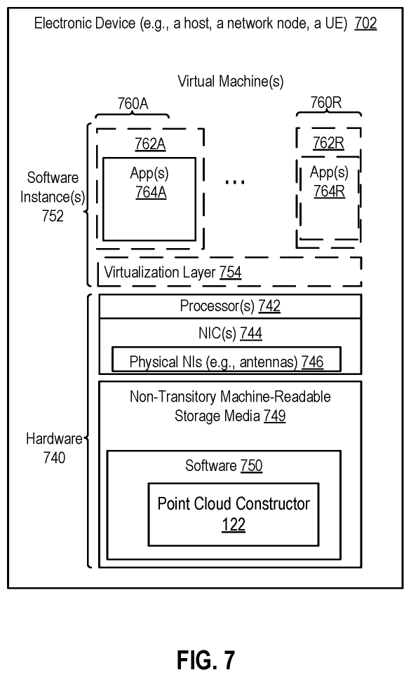

FIG. 7 shows an electronic device that performs range image interpolation based on gradients according to some aspects of the present disclosure. The electronic device 702 may be a host in a cloud system, or a network node/UE in a wireless/wireline network, and the operating environment and further embodiments the host, the network node, the UE are discussed in more details herein below. The electronic device 702 may be implemented using custom application-specific integrated-circuits (ASICs) as processors and a special-purpose operating system (OS), or common off-the-shelf (COTS) processors and a standard OS. In some embodiments, the electronic device 702 implements the point cloud constructor 122.

The electronic device 702 includes hardware 740 comprising a set of one or more processors 742 (which are typically COTS processors or processor cores or ASICs) and physical NIs 746, as well as non-transitory machine-readable storage media 749 having stored therein software 750. During operation, the one or more processors 742 may execute the software 750 to instantiate one or more sets of one or more applications 764A-R. While one embodiment does not implement virtualization, alternative embodiments may use different forms of virtualization. For example, in one such alternative embodiment, the virtualization layer 754 represents the kernel of an operating system (or a shim executing on a base operating system) that allows for the creation of multiple instances 762A-R called software containers that may each be used to execute one (or more) of the sets of applications 764A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 754 represents a hypervisor (sometimes referred to as a virtual machine monitor (VMM)) or a hypervisor executing on top of a host operating system, and each of the sets of applications 764A-R run on top of a guest operating system within an instance 762A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 740, directly on a hypervisor (in which case the unikernel is sometimes described as running within a LibOS virtual machine), or in a software container, embodiments can be implemented fully with unikernels running directly on a hypervisor represented by virtualization layer 754, unikernels running within software containers represented by instances 762A-R, or as a combination of unikernels and the above-described techniques (e.g., unikernels and virtual machines both run directly on a hypervisor, unikernels, and sets of applications that are run in different software containers).

The software 750 contains the point cloud constructor 122 that performs operations described with reference to operations as discussed relating to FIGS. 1 to 6. The point cloud constructor 122 may be instantiated within the applications 764A-R. The instantiation of the one or more sets of one or more applications 764A-R, as well as virtualization if implemented, are collectively referred to as software instance(s) 752. Each set of applications 764A-R, corresponding virtualization construct (e.g., instance 762A-R) if implemented, and that part of the hardware 740 that executes them (be it hardware dedicated to that execution and/or time slices of hardware temporally shared), forms a separate virtual electronic device 760A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 744. The physical network interface 746 may include one or more antenna of the electronic device 702. An antenna port may or may not correspond to a physical antenna. The antenna comprises one or more radio interfaces.

### A Wireless Network According to Some Aspects of the Present Disclosure

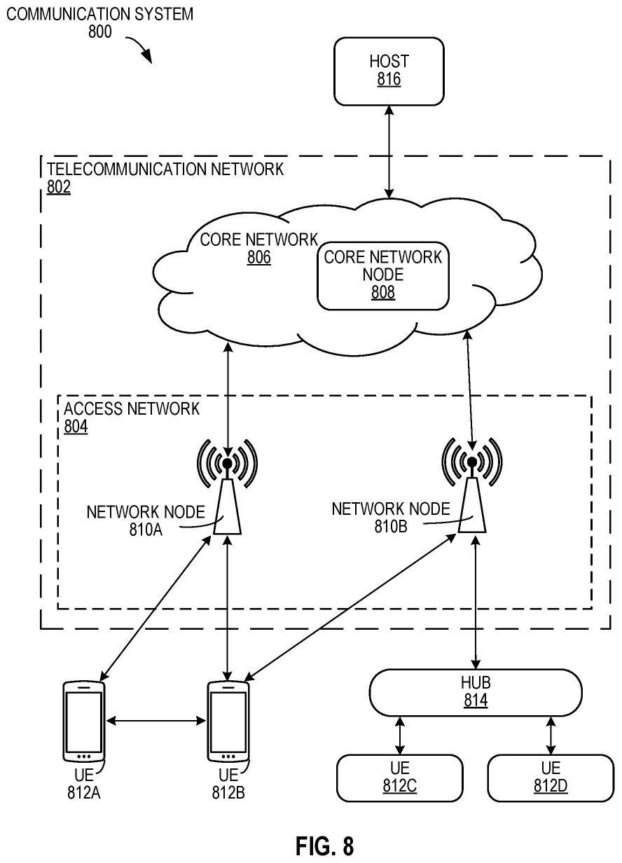

FIG. 8 illustrates an example of a communication system 800 according to some aspects of the present disclosure.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

### UE According to Some Aspects of the Present Disclosure

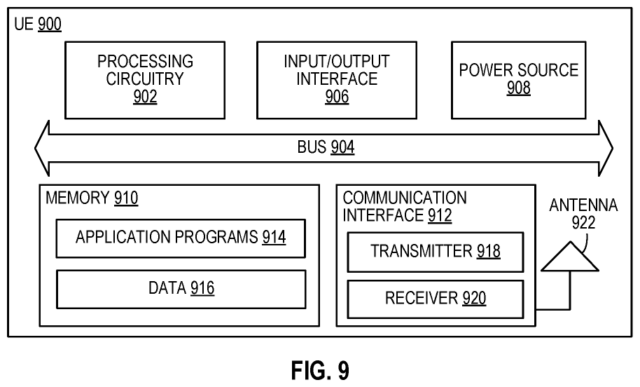

FIG. 9 illustrates a UE 900 according to some aspects of the present disclosure. As used herein, a UE refers to a device capable, configured, arranged and/or operable to communicate wirelessly with network nodes and/or other UEs. The electronic devices 102 to 104 may be implemented by a UE 900. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output subsystem 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output subsystem 906 may be configured to provide an interface or interfaces to an input device, output device, or one or more input and/or output devices and may include such input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, a LiDAR system, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following paragraphs describe several enumerated embodiments of the present disclosure.

1. A method to be implemented in an electronic device to interpolate pixels, comprising:
converting (602) point cloud data of a point cloud into one or more range images, wherein each pixel in a range image within the one or more range images is to map to a point represented by a set of cartesian coordinates in the point cloud and is represented by a depth value, a polar angle, and an azimuthal angle;
dividing (604) a range image within the one or more range images into a plurality of windows, each window including a set of pixels in the range image;
adding (606) one or more pixels to at least one window through interpolation of pixels within the window, wherein one or both gradients between a first pixel and the first pixel's two immediately adjacent pixels in the window are used to determine a first interpolated pixel to be added; and
converting (608) pixels within the plurality of windows with one or more interpolated pixels into updated point cloud data of the point cloud.

2. The method of embodiment 1, wherein converting the point cloud data of the point cloud into the one or more range images comprises at least one of:
selecting a subset of the point cloud data of the point cloud to map to the one or more range images, and
quantizing the range image mapping.

3. The method of any of embodiments 1 to 2, wherein dividing the range image into the plurality of windows may be performed either vertically or horizontally.

4. The method of any of embodiments 1 to 3, wherein adding the one or more pixels to the at least one window may be prioritized based on depth values of the pixels within the at least one window.

5. The method of any of embodiments 1 to 4, wherein the pixels with either lower depth values or higher depth values within the window are prioritized, based on an application type to apply the point cloud data.

6. The method of any of embodiments 1 to 5, wherein adding pixels to the plurality of windows is performed in parallel.

7. The method of any of embodiments 1 to 6, wherein determining the first interpolated pixel comprises selecting a least gradient magnitude of both gradients to determine the first interpolated pixel.

8. The method of any of embodiments 1 to 7, wherein a first interpolated depth of the first interpolated pixel is computed based on a first depth value of the first pixel and the least gradient magnitude.

9. The method of any of embodiments 1 to 8, wherein a second interpolated pixel is added when a second depth value of a second pixel is zero, and wherein the second interpolated pixel is added using two gradients, each for one immediately adjacent pixel of the second pixel and each gradient being a gradient on non-zero depth side of the one immediately adjacent pixel.

10. The method of any of embodiments 1 to 9, wherein the first interpolated pixel is assigned a same reflectance intensity value of the first pixel.

11. An electronic device comprising:
a processor (742) and machine-readable storage medium (749) that provides instructions that, when executed by the processor, are capable of causing the electronic device to perform:
converting (602) point cloud data of a point cloud into one or more range images, wherein each pixel in a range image within the one or more range images is to map to a point represented by a set of cartesian coordinates in the point cloud and is represented by a depth value, a polar angle, and an azimuthal angle;
dividing (604) a range image within the one or more range images into a plurality of windows, each window including a set of pixels in the range image;
adding (606) one or more pixels to at least one window through interpolation of pixels within the window, wherein one or both gradients between a first pixel and the first pixel's two immediately adjacent pixels in the window are used to determine a first interpolated pixel to be added; and
converting (608) pixels within the plurality of windows with one or more interpolated pixels into updated point cloud data of the point cloud.

12. The electronic device of embodiment 11, wherein converting the point cloud data of the point cloud into the one or more range images comprises at least one of:
selecting a subset of the point cloud data of the point cloud to map to the one or more range images, and
quantizing the range image mapping.

13. The electronic device of any of embodiments 11 to 12, wherein dividing the range image into the plurality of windows may be performed either vertically or horizontally.

14. The electronic device of any of embodiments 11 to 13, wherein adding the one or more pixels to the at least one window may be prioritized based on depth values of the pixels within the at least one window.

15. The electronic device of any of embodiments 11 to 14, wherein the pixels with either lower depth values or higher depth values within the window are prioritized, based on an application type to apply the point cloud data.

16. The electronic device of any of embodiments 11 to 15, wherein adding pixels to the plurality of windows is performed in parallel.

17. The electronic device of any of embodiments 11 to 16, wherein determining the first interpolated pixel comprises selecting a least gradient magnitude of both gradients to determine the first interpolated pixel.

18. The electronic device of any of embodiments 11 to 17, wherein a first interpolated depth of the first interpolated pixel is computed based on a first depth value of the first pixel and the least gradient magnitude.

19. The electronic device of any of embodiments 11 to 18, wherein a second interpolated pixel is added when a second depth value of a second pixel is zero, and wherein the second interpolated pixel is added using two gradients, each for one immediately adjacent pixel of the second pixel and each gradient being a gradient on non-zero depth side of the one immediately adjacent pixel.

20. The electronic device of any of embodiments 11 to 12, wherein the first interpolated pixel is assigned a same reflectance intensity value of the first pixel.

21. A machine-readable storage medium (749) that provides instructions that, when executed by a processor, are capable of causing the processor to perform any of methods 1 to 10.

22. A computer program that provides instructions that, when executed by a processor, are capable of causing the processor to perform any of methods 1 to 10.

1. A method to be implemented in an electronic device to interpolate pixels, comprising:
converting point cloud data of a point cloud into one or more range images, wherein each pixel in a range image of the one or more range images maps to a point represented by a set of cartesian coordinates in the point cloud and is represented by a depth value, a polar angle, and an azimuthal angle;
dividing a first range image of the one or more range images into a plurality of windows, each window including a set of pixels in the range image;
adding one or more pixels to at least one window through interpolation of pixels within the window, wherein one or both gradients between a first pixel and the two immediately adjacent pixels of the first pixel in the window are used to determine a first interpolated pixel to be added; and
converting pixels within the plurality of windows with one or more interpolated pixels into updated point cloud data of the point cloud.

2. The method of claim 1, wherein converting the point cloud data of the point cloud into the one or more range images comprises at least one of:
selecting a subset of the point cloud data of the point cloud to map to the one or more range images, and
quantizing the range image mapping.

3. The method of claim 1, wherein dividing the range image into the plurality of windows may be performed either vertically or horizontally.

4. The method of claim 1, wherein adding the one or more pixels to the at least one window may be prioritized based on depth values of the pixels within the at least one window.

5. The method of claim 1, wherein the pixels with either lower depth values or higher depth values within the window are prioritized, based on an application type to apply the point cloud data.

6. The method of claim 1, wherein adding pixels to the plurality of windows is performed in parallel.

7. The method of claim 1, wherein determining the first interpolated pixel comprises selecting a least gradient magnitude of both gradients to determine the first interpolated pixel.

8. The method of claim 1, wherein a first interpolated depth of the first interpolated pixel is computed based on a first depth value of the first pixel and the least gradient magnitude.

9. The method of claim 1, wherein a second interpolated pixel is added when a second depth value of a second pixel is zero, and wherein the second interpolated pixel is added using two gradients, each for one immediately adjacent pixel of the second pixel and each gradient being a gradient on non-zero depth side of the one immediately adjacent pixel.

10. The method of claim 1, wherein the first interpolated pixel is assigned a same reflectance intensity value of the first pixel.

11. An electronic device comprising:
a processor and machine-readable storage medium that provides instructions that, when executed by the processor, are capable of causing the electronic device to perform:
converting point cloud data of a point cloud into one or more range images, wherein each pixel in a range image within the one or more range images is to map to a point represented by a set of cartesian coordinates in the point cloud and is represented by a depth value, a polar angle, and an azimuthal angle;
dividing a range image within the one or more range images into a plurality of windows, each window including a set of pixels in the range image;
adding one or more pixels to at least one window through interpolation of pixels within the window, wherein one or both gradients between a first pixel and the first pixel's two immediately adjacent pixels in the window are used to determine a first interpolated pixel to be added; and
converting pixels within the plurality of windows with one or more interpolated pixels into updated point cloud data of the point cloud.

12. The electronic device of claim 11, wherein converting the point cloud data of the point cloud into the one or more range images comprises at least one of:
selecting a subset of the point cloud data of the point cloud to map to the one or more range images, and
quantizing the range image mapping.

13. The electronic device of claim 11, wherein
dividing the range image into the plurality of windows may be performed either vertically or horizontally.

14. The electronic device of claim 11, wherein adding the one or more pixels to the at least one window may be prioritized based on depth values of the pixels within the at least one window.

15. The electronic device of claim 11, wherein the pixels with either lower depth values or higher depth values within the window are prioritized, based on an application type to apply the point cloud data.

16. The electronic device of claim 11, wherein adding pixels to the plurality of windows is performed in parallel.

17. The electronic device of claim 11, wherein determining the first interpolated pixel comprises selecting a least gradient magnitude of both gradients to determine the first interpolated pixel.

18. The electronic device of claim 11, wherein a first interpolated depth of the first interpolated pixel is computed based on a first depth value of the first pixel and the least gradient magnitude.

19. The electronic device of claim 11, wherein a second interpolated pixel is added when a second depth value of a second pixel is zero, and wherein the second interpolated pixel is added using two gradients, each for one immediately adjacent pixel of the second pixel and each gradient being a gradient on non-zero depth side of the one immediately adjacent pixel.

20. The electronic device of claim 11, wherein the first interpolated pixel is assigned a same reflectance intensity value of the first pixel.

21. (canceled)
